(19) United States
(12) Patent Application Publication
(10) Pub. No.: US 2010/0244659 A1
(43) Pub. Date: Sep. 30, 2010

(54) PLASMA DISPLAY PANEL

(75) Inventors: Shingo Takagi, Osaka (JP); Hatsumi Komaki, Osaka (JP); Ryoji Hyuga, Osaka (JP); Tatsuo Mifune, Osaka (JP)

Correspondence Address: RATNERPRESTIA, P.O. BOX 980, VALLEY FORGE, PA, 19482, US

(73) Assignee: PANASONIC CORPORATION, Osaka (JP)

(21) Appl. No.: 12/294,492

(22) PCT Filed: Mar. 25, 2008
(86) PCT No.: PCT/JP2008/000701

§ 371 Date: Sep. 25, 2008

(30) Foreign Application Priority Data
May 28, 2007 (JP) 2007-139880

(51) Int. Cl. H01J 63/04

(52) U.S. Cl. 313/491

(57) ABSTRACT

A Plasma Display Panel includes a front panel having a display electrode and a dielectric layer formed on a glass substrate; and a rear panel having an electrode, a barrier rib, and a phosphor layer formed on a substrate. The front panel and the rear panel are disposed facing each other and sealed together at peripheries thereof with discharge space provided therebetween. The display electrode has at least a metal bus electrode including a metal electrode layer containing silver and a glass material, and a black layer containing a black material and a glass material. The glass material of the metal electrode layer and the black layer includes bismuth oxide. An undercut amount of the metal bus electrode is 25 μm or more.

### TECHNICAL FIELD

The present invention relates to a plasma display panel used in a display device, and the like.

### BACKGROUND ART

Since a plasma display panel (hereinafter, referred to as “PDP”) can achieve high definition and a large screen, a television of 100-inch class or more is commercialized. Recently, PDPs have been applied to high definition televisions with full specification in which the number of scan lines is twice or more than that of the conventional National Television System Committee (NTSC) system. Furthermore, from the viewpoint of environmental problems, PDPs without containing a lead component have been demanded. Furthermore, it has been necessary to reduce expensive and rare metals for saving resources and reducing material costs.

A PDP basically includes a front panel and a rear panel. The front panel includes a glass substrate of sodium borosilicate glass produced by a float process; display electrodes each composed of striped transparent electrode and bus electrode formed on one main surface of the glass substrate; a dielectric layer covering the display electrodes and functioning as a capacitor; and a protective layer made of magnesium oxide (MgO) formed on the dielectric layer. On the other hand, the rear panel includes a glass substrate; striped address electrodes formed on one main surface of the glass substrate; a base dielectric layer covering the address electrodes; barrier ribs formed on the base dielectric layer; and phosphor layers formed between the barrier ribs and emitting red, green and blue light, respectively.

The front panel and the rear panel are hermetically sealed so that their surfaces having electrodes face each other. Discharge gas of Ne—Xe is filled in discharge space partitioned by the barrier ribs at a pressure ranging from 400 Torr to 600 Torr. The PDP realizes a color image display by selectively applying a video signal voltage to a display electrode so as to cause electric discharge, thus exciting a phosphor layer of each color with ultraviolet ray generated by the electric discharge so as to emit red, green and blue light.

For the bus electrode of the display electrode, a silver electrode for securing conductivity is used. For the dielectric layer, a low melting point glass containing lead oxide as a main component is used. However, from the viewpoint of recent environmental problems, examples in which a dielectric layer does not contain a lead component have been disclosed (see, for example, patent documents 1, 2, 3 and 4).

Furthermore, an example in which a glass material used for forming an electrode contains a predetermined amount of bismuth oxide (Bi₂O₃) is also disclosed (see, for example, patent document 5).

Recently, PDPs have been applied to high definition televisions with full specification in which the number of scan lines is twice or more than that of a conventional NTSC system. With such a trend toward a large screen as mentioned above, voltage and electric power required to display images are inevitably increased. Therefore, reducing a resistance value of a display electrode is important.

However, in order to reduce a resistance value of a display electrode, it is necessary to increase a cross-sectional area of the electrode. However, when the width of the electrode is increased, an opening area for transmitting visible light of a pixel for image display is reduced. As a result, the luminance of image display of PDP is deteriorated. On the other hand, when the thickness of the electrode is increased, the thickness of the dielectric layer on the upper part of the electrode is substantially reduced. Consequently, the withstand voltage of the dielectric layer is deteriorated.

In particular, when glass materials without containing a lead component, which are used from the viewpoint of environmental problems, are used for the dielectric layer or electrode, it tends to be difficult to reduce a resistance value of a display electrode.

[Patent Document 1] Japanese Patent Application Unexamined Publication No. 2003-128430

[Patent Document 2] Japanese Patent Application Unexamined Publication No. 2002-053342

[Patent Document 3] Japanese Patent Application Unexamined Publication No. 2001-045877

[Patent Document 4] Japanese Patent Application Unexamined Publication No. H9-050769

[Patent Document 5] Japanese Patent Application Unexamined Publication No. 2000-048645

### SUMMARY OF THE INVENTION

A PDP of the present invention includes a front panel having a display electrode and a dielectric layer formed on a glass substrate; and a rear panel having an electrode, a barrier rib, and a phosphor layer formed on a substrate. The front panel and the rear panel are disposed facing each other and sealed together at peripheries thereof with discharge space provided therebetween. The display electrode has at least a metal bus electrode including a metal electrode layer containing silver and a glass material, and a black layer containing a black material and a glass material. The glass material of the metal electrode layer and the black layer includes bismuth oxide. Furthermore, an undercut amount of the metal bus electrode is 25 μm or more.

With such a configuration, even when an environmentally friendly material that does not contain a lead component is used, it is possible to realize a PDP maintaining a resistance value of the display electrode and having high luminance and high reliability.

Furthermore, according to the present invention, an edge curl amount of the metal bus electrode may be 70% or less with respect to the film thickness of the metal bus electrode.

Furthermore, the black layer may contain at least one of cobalt (Co), nickel (Ni), copper (Cu), oxide of cobalt (Co), oxide of nickel (Ni), and oxide of copper (Cu).

### BRIEF DESCRIPTION OF THE DRAWINGS

FIG. 1 is a perspective view showing a structure of a PDP in accordance with an exemplary embodiment of the present invention.

FIG. 2 is a sectional view showing a configuration of a front panel of the PDP according to an embodiment of the invention.

FIG. 3 is a sectional view showing a shape of a metal bus electrode and the front panel after development.

FIG. 4 is a sectional view showing a shape of the metal bus electrode and the front panel after firing.

### REFERENCE MARKS IN THE DRAWINGS

1 PDP
2 front panel
3 front glass substrate
4 scan electrode
4a, 5a transparent electrode
4b, 5b metal bus electrode
5 sustain electrode
6 display electrode
7 light blocking layer
8 dielectric layer
9 protective layer
10 rear panel
11 rear glass substrate
12 address electrode
13 base dielectric layer
14 barrier rib
15 phosphor layer
16 discharge space
41b, 51b black electrode (black layer)
42b, 52b white electrode (metal electrode layer)
81 first dielectric layer
82 second dielectric layer

### DETAILED DESCRIPTION OF THE PREFERRED EMBODIMENTS

Hereinafter, a PDP in accordance with an exemplary embodiment of the present invention is described with reference to drawings.

### Exemplary Embodiment

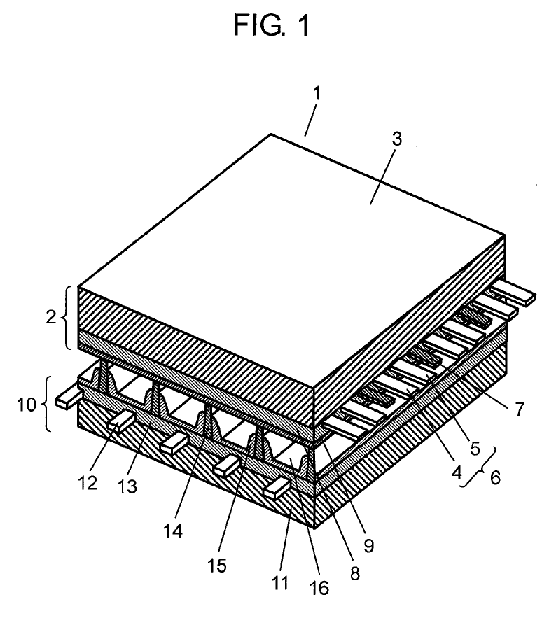

FIG. 1 is a perspective view showing a structure of a PDP in accordance with an exemplary embodiment of the present invention. The basic structure of the PDP is the same as that of a general AC surface-discharge type PDP. As shown in FIG. 1, PDP 1 includes front panel 2 including front glass substrate 3, and the like, and rear panel 10 including rear glass substrate 11, and the like. Front panel 2 and rear panel 10 are disposed facing each other and hermetically sealed together at the peripheries thereof with a sealing material including a glass frit, and the like. In discharge space 16 inside the sealed PDP 1, discharge gas such as Ne and Xe, is filled in at a pressure ranging from 400 Torr to 600 Torr.

A plurality of stripe-like display electrodes 6 each composed of a pair of scan electrode 4 and sustain electrode 5 and light blocking layers 7 are disposed in parallel to each other on front glass substrate 3 of front panel 2. Dielectric layer 8 functioning as a capacitor is formed so as to cover display electrodes 6 and light blocking layers 7 on front glass substrate 3. In addition, protective layer 9 made of, for example, magnesium oxide (MgO) is formed on the surface of dielectric layer 8.

Furthermore, on rear glass substrate 11 of rear panel 10, a plurality of address electrodes 12 as stripe-like electrodes are disposed in parallel to each other in the direction orthogonal to scan electrodes 4 and sustain electrodes 5 of front panel 2, and base dielectric layer 13 covers address electrodes 12. In addition, barrier ribs 14 with a predetermined height for partitioning discharge space 16 are formed between address electrodes 12 on base dielectric layer 13. Phosphor layers 15 emitting red, blue and green light by ultraviolet ray are sequentially formed by coating in grooves between barrier ribs 14 for each address electrode 12. Discharge cells are formed in positions in which scan electrodes 4, sustain electrodes 5 and address electrodes 12 intersect each other. The discharge cells having red, blue and green phosphor layers 15 arranged in the direction of display electrode 6 function as pixels for color display.

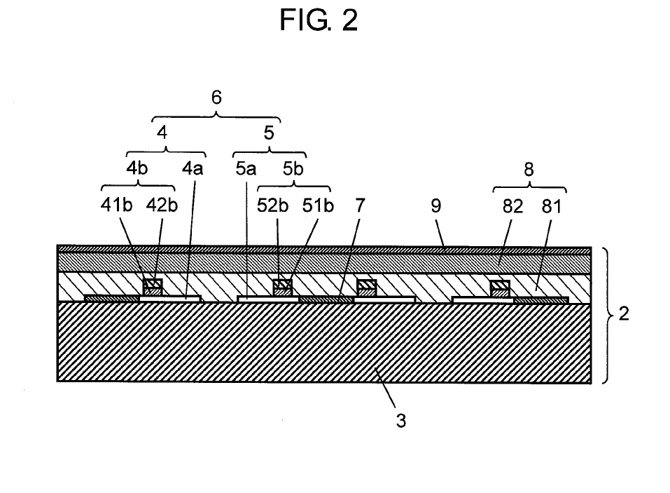

FIG. 2 is a sectional view showing a configuration of front panel 2 of the PDP in accordance with an exemplary embodiment of the present invention. FIG. 2 is shown turned upside down with respect to FIG. 1. As shown in FIG. 2, display electrodes 6 each composed of scan electrode 4 and sustain electrode 5 and light blocking layers 7 are patterned on front glass substrate 3 produced by, for example, a float method. Scan electrode 4 and sustain electrode 5 include transparent electrodes 4a and 5a made of indium tin oxide (ITO), tin oxide (SnO₂), or the like, and metal bus electrodes 4b and 5b formed on transparent electrodes 4a and 5a, respectively. Metal bus electrodes 4b and 5b are used for the purpose of providing the conductivity in the longitudinal direction of transparent electrodes 4a and 5a and formed of a conductive material containing a silver (Ag) material as a main component. Furthermore, metal bus electrodes 4b and 5b include black electrodes 41b and 51b as a black layer and white electrodes 42b and 52b as a metal electrode layer.

Dielectric layer 8 includes at least two layers, that is, first dielectric layer 81 and second dielectric layer 82. First dielectric layer 81 is provided for covering transparent electrodes 4a and 5a, metal bus electrodes 4b and 5b, and light blocking layers 7 formed on front glass substrate 3. Second dielectric layer 82 is formed on first dielectric layer 81. In addition, protective layer 9 is formed on second dielectric layer 82.

Next, a method of manufacturing a PDP is described. Firstly, scan electrodes 4, sustain electrodes 5 and light blocking layers 7 are formed on front glass substrate 3. Transparent electrodes 4a and 5a and metal bus electrodes 4b and 5b are formed by patterning by, for example, a photolithography method. Transparent electrodes 4a and 5a are formed by, for example, a thin film process. Metal bus electrodes 4b and 5b are formed by firing a paste including conductive black particles or a silver material at a predetermined temperature and solidifying it. Furthermore, light blocking layer 7 is similarly formed by patterning a paste including a black material by a method of screen printing or a method of forming a black material over the entire surface of the glass substrate, then carrying out a photolithography method, and firing it.

As a specific procedure for forming metal bus electrodes 4b and 5b, the following procedure is generally carried out. A paste including a black material is printed on front glass substrate 3 and dried, and then patterned by a photolithography method so as to form light blocking layer 7. Furthermore, thereon, a paste including a pigment and a paste including conductive particles are printed and dried, repeatedly. Thereafter, they are patterned by a photolithography method so as to form metal bus electrodes 4b and 5b composed of black electrodes 41b and 51b and white electrodes 42b and 52b. Herein, in order to improve the contrast at the time of image display, black electrodes 41b and 51b are formed on the lower layer (at the side of front glass substrate 3) and white electrodes 42b and 52b are formed on the upper layer.

In the exemplary embodiment of the present invention, black electrodes 41b and 51b of metal bus electrodes 4b and 5b and light blocking layer 7 are made of the same material and manufactured by the same process. Since the present invention is a technology for improving the degree of black, in the exemplary embodiment of the present invention, the degree of black of light blocking layer 7 becomes excellent. Therefore, the effect of the present invention can be strengthened.

Next, a dielectric paste is coated on front glass substrate 3 by, for example, a die coating method so as to cover scan electrodes 4, sustain electrodes 5 and light blocking layers 7, thus forming a dielectric paste layer (dielectric glass layer). After the dielectric paste is coated, it is stood still for a predetermined time. Thereby, the surface of the coated dielectric paste is leveled and flattened. Thereafter, by firing and solidifying the dielectric paste layer, dielectric layer 8 covering scan electrodes 4, sustain electrodes 5 and light blocking layers 7 is formed. In the exemplary embodiment of the present invention, by repeating at least coating of these dielectric pastes, two-layered dielectric layer 8 including first dielectric layer 81 and second dielectric layer 82 is formed. Note here that the dielectric paste is a coating material including dielectric glass powder, a binder and a solvent. Next, protective layer 9 made of magnesium oxide (MgO) is formed on dielectric layer 8 by a vacuum evaporation method. With the above-mentioned process, predetermined component members are formed on front glass substrate 3. Thus, front panel 2 is completed.

On the other hand, rear panel 10 is formed as follows. Firstly, a material layer as components for address electrode 12 is formed on rear glass substrate 11 by a method of screen printing a paste including a silver (Ag) material, a method of forming a metal film over the entire surface, and then patterning it by a photolithography method, or the like. The material layer is fired at a predetermined temperature so as to form address electrode 12. Next, a dielectric paste is coated by, for example, a die coating method so as to cover address electrodes 12 on rear glass substrate 11 on which address electrodes 12 are formed. Thus, a dielectric paste layer is formed. Thereafter, by firing the dielectric paste layer, base dielectric layer 13 is formed. Note here that a dielectric paste is a coating material including dielectric glass powder, a binder, and a solvent.

Next, by coating a barrier rib formation paste including materials for barrier ribs on base dielectric layer 13 and patterning it into a predetermined shape, a barrier rib material layer is formed, and then fired. Thus, barrier ribs 14 are formed. Herein, a method of patterning the barrier rib formation paste coated on base dielectric layer 13 may include a photolithography method and a sand-blast method. Next, a phosphor paste including a phosphor material is coated between neighboring barrier ribs 14 on base dielectric layer 13 and on the side surfaces of barrier ribs 14, and fired. Thus, phosphor layer 15 is formed. As mentioned above, predetermined component members are formed on rear glass substrate 11, and rear panel 10 is completed.

In this way, front panel 2 and rear panel 10, which include predetermined component members, are disposed facing each other such that scan electrodes 4 and address electrodes 12 are disposed orthogonal to each other, and sealed together at the peripheries thereof with a glass frit. Discharge gas including, for example, Ne and Xe, is filled in discharge space 16. Thus, PDP 1 is completed.

Next, the details of display electrode 6 and dielectric layer 8 of front panel 2 are described. Firstly, display electrode 6 is described. Indium tin oxide (ITO) having a thickness of about 0.12 μm is formed over the entire surface of front glass substrate 3 by a sputtering method. Thereafter, by a photolithography method, striped transparent electrodes 4a and 5a having a width of 150 μm are formed.

Then, a photosensitive paste is coated over the entire upper surface of front glass substrate 3 by a printing method, or the like, to form a black electrode paste layer as a black layer. Note here that a photosensitive paste to be formed into a black layer includes 5% to 40% inclusive by weight of a black material, that is, at least one of black metal particles of cobalt (Co), black metal particles of nickel (Ni), black metal particles of copper (Cu), metal oxide of cobalt (Co), metal oxide of nickel (Ni), metal oxide of copper (Cu), composite metal oxide of cobalt (Co), composite metal oxide of nickel (Ni), and composite metal oxide of copper (Cu); 10% to 40% inclusive by weight of a glass material; and 30% to 60% inclusive by weight of photosensitive organic binder component including a photosensitive polymer, a photosensitive monomer, a photopolymerization initiator, a solvent, and the like. That is to say, display electrode 6 includes at least a plurality of layers including metal bus electrodes 4b and 5b each composed of a metal electrode layer containing at least silver and a glass material and a black layer containing a black material and a glass material.

Note here that the glass material of the black electrode paste layer includes at least 5% to 25% inclusive by weight of bismuth oxide (Bi₂O₃) and has a softening point of more than 500° C. Note here that the black metal particles, metal oxide, and composite metal oxide of cobalt (Co), nickel (Ni), and copper (Cu), as the black material mentioned above also function as a partially conductive material.

Next, a photosensitive paste is coated on a black electrode paste layer by a printing method or the like so as to form a white electrode paste layer as a metal electrode layer. The photosensitive paste includes at least 70% to 90% inclusive by weight of silver (Ag) particles; 1% to 15% inclusive by weight of glass material; and 8% to 30% inclusive by weight of photosensitive organic binder component including a photosensitive polymer, a photosensitive monomer, a photopolymerization initiator, a solvent, and the like. Furthermore, the glass material of the white electrode paste layer includes 5% to 25% inclusive by weight of bismuth oxide (Bi₂O₃) and has a softening point of more than 550° C.

These black electrode paste layer and white electrode paste layer, which are coated over the entire surface, are patterned by using a photolithography method. Then, the patterned black electrode paste layer and white electrode paste layer are fired at a temperature raging from 550° C. to 600° C. Thus, black electrodes 41b and 51b and white electrodes 42b and 52b having a line width of about 60 μm are formed on transparent electrodes 4a and 5a.

Thus, in the exemplary embodiment of the present invention, cobalt (Co), nickel (Ni), and copper (Cu) are used for black electrodes 41b and 51b. On the other hand, in a conventional technology, by allowing black electrodes 41b and 51b and light blocking layer 7 to contain chromium (Cr), manganese (Mn) and iron (Fe), the conductivity and the degree of black are secured. However, the present inventors have found that use of chromium (Cr), manganese (Mn), and iron (Fe) for black electrodes 41b and 51b tends to increase the contact resistance value on the layer interface between black electrodes 41b and 51b and white electrodes 42b and 52b, and to increase the resistance value of the entire electrode layer. Furthermore, it is determined that this tendency is also dependent upon components of the glass material of black electrodes 41b and 51b, or components of dielectric layer 8, or the like.

This phenomenon is described below. In general, silvers (Ag) included in white electrodes 42b and 52b are brought into contact with each other by heat treatment in firing of the electrode and firing of the dielectric layer, and thereby the conductivity of the electrode is expressed. However, in general, the components such as conductive material and black material included in black electrodes 41b and 51b move and diffuse to white electrodes 42b and 52b in firing of the electrode and firing of the dielectric layer mentioned above, preventing silvers (Ag) from being brought into contact with each other. However, when cobalt (Co), nickel (Ni), and copper (Cu) are used for black electrodes 41b and 51b, diffusion of components such as conductive material and black material included in black electrodes 41b and 51b to white electrodes 42b and 52b is suppressed. As a result, silvers (Ag) are not prevented from being brought into contact with each other. Therefore, it is thought that contact resistance value on the layer interface between black electrodes 41b and 51b and white electrodes 42b and 52b can be reduced.

On the other hand, when components of chromium (Cr), manganese (Mn) and iron (Fe) are contained as the black material or the conductive material in the black electrode, the components such as the conductive material and the black material contained in the black electrodes 41b and 51b diffuse to white electrodes 42b and 52b at the time of firing. As a result, the diffused components prevent silvers (Ag) from being brought into contact with each other. Thus, the above-mentioned contact resistance value on the layer interface is increased.

Furthermore, a conventional technology also discloses a means for securing the degree of black and the conductivity by allowing black electrodes 41b and 51b or light blocking layer 7 to contain ruthenium (Ru). However, since ruthenium (Ru) is expensive and rare metal, use of ruthenium (Ru) leads to an increase in the material cost. Therefore, PDPs whose screen size is increased is significantly affected by even an increase of the partial cost. In this way, the exemplary embodiment of the present invention does not substantially use ruthenium (Ru), so that it can have advantageous effect over a conventional technology from the viewpoint of reducing material costs or saving resources.

Furthermore, it is preferable that the glass materials used for black electrodes 41b and 51b and white electrodes 42b and 52b contain 5% to 25% inclusive by weight of bismuth oxide (Bi₂O₃) and furthermore, 0.1% by weight or more and 7% by weight or less of at least one of molybdenum oxide (MoO₃) and tungsten oxide (WO₃). Note here that instead of molybdenum oxide (MoO₃) and tungsten oxide (WO₃), 0.1% to 7% inclusive by weight of at least one selected from cerium oxide (CeO₂), copper oxide (CuO), cobalt oxide (CO₂O₃), vanadium oxide (V₂O₇), and antimony oxide (Sb₂O₃) may be included.

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

In the present invention, the glass material is made to have a softening point temperature of 500° C. or higher, and the firing temperature is made to be a range from 550° C. to 600° C. As in the conventional technology, when the softening point of the glass material is as low as a range from 450° C. to 500° C., the firing temperature is higher than the softening point of the glass material by about 100° C. Therefore, highly reactive bismuth oxide (Bi₂O₃) itself vigorously reacts with silver (Ag) or black metal particles or an organic binder component in the paste. As a result, bubbles are generated in metal bus electrodes 4b and 5b and dielectric layer 8, deteriorating the withstand voltage performance of dielectric layer 8. On the other hand, according to the present invention, when the softening point of the glass material is made to be 500° C. or higher, the reactivity between bismuth oxide (Bi₂O₃) and silver (Ag), black metal particles or an organic component is deteriorated, and the generation of bubbles is reduced. However, it is not desirable that the softening point of the glass material is made to 600° C. or higher because the adhesiveness of metal bus electrodes 4b and 5b with respect to transparent electrodes 4a and 5a or front glass substrate 3 or with respect to dielectric layer 8 is deteriorated.

The exemplary embodiment of the present invention employs a method of exposing and developing the above-mentioned black electrode paste layer and white electrode paste layer at one time when patterning is carried out by using a photolithography method. Specifically, in order to carry out patterning of light blocking layer 7 after the black electrode paste layer is formed, light blocking layer 7 is irradiated with and exposed to an active ray via a mask having this pattern. Thereafter, a white electrode paste layer is formed on the black electrode paste layer. Then, in order to carry out patterning of metal bus electrodes 4b and 5b, metal bus electrodes 4b and 5b are irradiated with and exposed to an active ray via a mask having this pattern.

Next, a non-exposed portion of each paste layer is removed with a developing solution. Then, after exposure and development, firing is carried out. Thereby, an alkali-soluble polymer binder, a polymerizable monomer, and a photopolymerization initiator are thermally decomposed and removed. The firing temperature is a range from 500° C. to 650° C. at maximum although it depends upon the kinds of basic inorganic powder to be used.

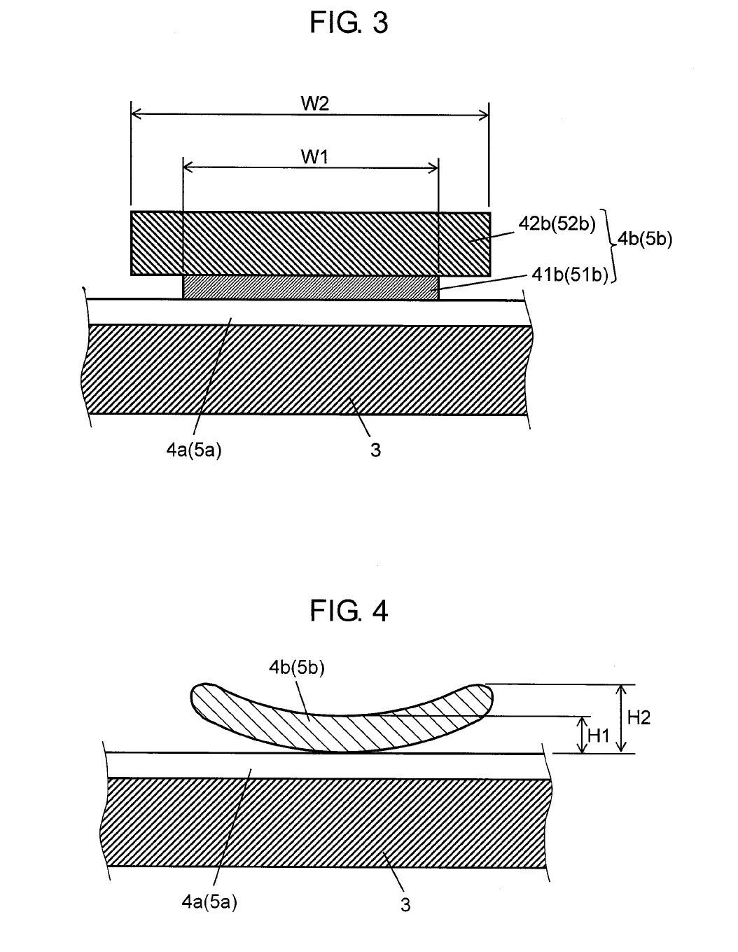

FIG. 3 shows a sectional shape of metal bus electrodes 4b and 5b after development. As mentioned above, in the exemplary embodiment of the present invention, the upper and lower layers are exposed at one time. In this case, the above-mentioned active ray may not reach the black electrode paste layer as a lower layer sufficiently, so that the lower layer may not be hardened satisfactorily. As a result, the amount of paste to be removed at the time of development is increased in the lower layer that is not hardened satisfactorily as compared with the upper layer. Consequently, the width of the lower layer may be smaller with respect to the width of the upper layer in the state after development. This phenomenon is generally called an “undercut.” In the exemplary embodiment of the present invention, as shown in FIG. 3, the difference value between width W1 that is in contact with the side of the substrate of metal bus electrodes 4b and 5b and projection width W2 of metal bus electrodes 4b and 5b is referred to as an “undercut amount.”

The undercut amount of metal bus electrodes 4b and 5b strongly depends upon the conditions at the time of exposure and development and can be adjusted based on the conditions at the time of exposure and development. The present inventors have found that in the present invention, as this undercut amount is increased, the thermal contraction amount of metal bus electrodes 4b and 5b tends to be increased by the thermal history in firing after development.

As a result, the density of white electrodes 42b and 52b of metal bus electrodes 4b and 5b can be enhanced. In the exemplary embodiment of the present invention, by using this tendency, the conductivity of the electrode can be increased. Specifically, the undercut amount is made to be 25 μm or more regardless of the electrode width of metal bus electrodes 4b and 5b and width W1 that is in contact with the substrate side is made to be 10 μm or more with the effect of film exfoliation and the like taken into consideration.

Therefore, in the formation of metal bus electrodes 4b and 5b having the same resistance value, the film thickness of metal bus electrodes 4b and 5b, in particular, white electrodes 42b and 52b can be reduced in the present invention as compared with a conventional technology.

On the other hand, when a film layer having a large thickness is developed and fired by the above-mentioned means, the end portions of the sectional surface of metal bus electrodes 4b and 5b may be warped due to the difference in the thermal contraction between the upper and lower layers. FIG. 4 is a sectional view showing metal bus electrodes 4b and 5b after firing. In general, this phenomenon is called an edge curl. In the exemplary embodiment of the present invention, as shown in FIG. 4, the difference value between film thickness H1 at the center with respect to the width direction of metal bus electrodes 4b and 5b and film thickness H2 at metal bus electrodes 4b and 5b at the end portions is defined as an edge curl amount.

In general, the edge curl amount tends to be increased in accordance with the increase in the film thickness of metal bus electrodes 4b and 5b. Furthermore, when the edge curl amount is increased, the substantial film thickness of dielectric layer 8 at the top portion may be reduced, and the dielectric breakdown voltage of dielectric layer 8 is also reduced, resulting in deterioration of the yield at the time of manufacture.

However, in the exemplary embodiment of the present invention, as mentioned above, since the film thickness of metal bus electrodes 4b and 5b can be reduced, the edge curl amount can be also reduced, resulting in achieving a PDP with high reliability and contributing the improvement of the yield in manufacture. Specifically, the edge curl amount is 70% or less with respect to the film thickness at the center in the width direction of metal bus electrodes 4b and 5b. These exemplary embodiments are described later.

In the exemplary embodiment of the present invention, in pattering of both light blocking layer 7 and metal bus electrodes 4b and 5b, the exposure amount of active ray is a range from 50 mJ/cm² to 500 mJ/cm² when an extra-high pressure mercury lamp is used.

In this way, in the exemplary embodiment of the present invention, the undercut amount is 25 μm or more and the edge curl amount is 70% or less with respect to the film thickness at the center in the width direction of metal bus electrodes 4b and 5b after firing. Thus, even when an environmentally friendly material that does not contain a lead component is used, the reliability of a PDP can be secured and the quality of image display can be improved without increasing the resistance value of metal bus electrodes 4b and 5b.

Next, first dielectric layer 81 and second dielectric layer 82 constituting dielectric layer 8 of front panel 2 are described in detail. A dielectric material of first dielectric layer 81 includes the following material compositions. That is to say, the material includes 5% to 25% inclusive by weight of bismuth oxide (Bi₂O₃) and 0.5% to 15% inclusive by weight of calcium oxide (CaO). Furthermore, it includes 0.1% to 7% inclusive by weight of at least one selected from molybdenum oxide (MoO₃), tungsten oxide (WO₃), cerium oxide (CeO₂), and manganese oxide (MnO₂).

Furthermore, it includes 0.5% to 12% inclusive by weight of at least one selected from strontium oxide (SrO) and barium oxide (BaO).

Note here that it may include 0.1% to 7% inclusive by weight of at least one selected from copper oxide (CuO), chromium oxide (Cr₂O₃), cobalt oxide (CO₂O₃), vanadium oxide (V₂O₇) and antimony oxide (Sb₂O₃), instead of molybdenum oxide (MoO₃), tungsten oxide (WO₃), cerium oxide (CeO₂), and manganese oxide (MnO₂).

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

The dielectric materials including these composition components are ground to have an average particle diameter ranging from 0.5 μm to 2.5 μm by using a wet jet mill or a ball mill. Thus, dielectric material powder is formed. Then, 55% to 70% inclusive by weight of this dielectric material powder and 30% to 45% inclusive by weight of binder component are well kneaded by using three rolls to form a paste for the first dielectric layer to be used in die coating or printing.

Then, this first dielectric layer paste is printed on front glass substrate 3 by a die coating method or a screen printing method so as to cover display electrodes 6, dried, and then fired at a temperature ranging from 575° C. to 590° C., that is, a slightly higher temperature than the softening point of the dielectric material.

Next, second dielectric layer 82 is described. A dielectric material of second dielectric layer 82 includes the following material compositions. That is to say, the material composition includes 5% to 25% inclusive by weight of bismuth oxide (Bi₂O₃) and 6.0% to 28% inclusive by weight of barium oxide (BaO). Furthermore, it includes 0.1% to 7% inclusive by weight of at least one selected from molybdenum oxide (MoO₃), tungsten oxide (WO₃), cerium oxide (CeO₂), and manganese oxide (MnO₂).

Furthermore, it includes 0.8% to 17% inclusive by weight of at least one selected from calcium oxide (CaO) and strontium oxide (SrO).

Note here that it may include 0.1% to 7% inclusive by weight of at least one selected from copper oxide (CuO), chromium oxide (Cr₂O₃), cobalt oxide (CO₂O₃), vanadium oxide (V₂O₇) and antimony oxide (Sb₂O₃), instead of molybdenum oxide (MoO₃), tungsten oxide (WO₃), cerium oxide (CeO₂), and manganese oxide (MnO₂).

Furthermore, as the components other than the components mentioned above, a material composition that does not include a lead component, for example, 0% to 40% inclusive by weight of zinc oxide (ZnO), 0% to 35% inclusive by weight of boron oxide (B₂O₃), 0% to 15% inclusive by weight of silicon oxide (SiO₂) and 0% to 10% inclusive by weight of aluminum oxide (Al₂O₃) may be contained. The contents of such material compositions are not particularly limited, and the contents of material compositions may be around the range of conventional technology.

The dielectric materials including these composition components are ground to have an average particle diameter ranging from 0.5 μm to 2.5 μm by using a wet jet mill or a ball mill. Thus, dielectric material powder is formed. Then, 55% to 70% inclusive by weight of this dielectric material powder and 30% to 45% inclusive by weight of binder component are well kneaded by using three rolls to form a second dielectric layer paste to be used in die coating or printing. Then, this second dielectric layer paste is printed on first dielectric layer 81 by a screen printing method or a die coating method, dried, and then fired at a temperature ranging from 550° C. to 590° C., that is, a slightly higher temperature than the softening point of the dielectric material.

As the film thickness of dielectric layer 8 is smaller, the effect of improving the panel luminance and reducing the discharge voltage becomes remarkable. Therefore, it is desirable that the film thickness is made to be as small as possible within a range in which a withstand voltage is not reduced. From the viewpoint of such conditions and visible light transmittance, in the exemplary embodiment of the present invention, the film thickness of dielectric layer 8 is set to be 41 μm or less, that of first dielectric layer 81 is set to be a range from 5 μm to 15 μm, and that of second dielectric layer 82 is set to be a range from 20 μm to 36 μm.

As mentioned above, the amount of bismuth oxide (Bi₂O₃) included in dielectric layer 8 of both first dielectric layer 81 and second dielectric layer 82 in the present invention is made to be 5% to 25% inclusive by weight as mentioned above. When the amount of bismuth oxide (Bi₂O₃) contained in dielectric layer 8 is made to be within this range, the degree of black of the PDP can be enhanced, and the desired softening point and dielectric constant of dielectric layer 8 can be achieved. Note here that it is not necessary that the amount of bismuth oxide (Bi₂O₃) of first dielectric layer 81 and the amount of second dielectric layer 82 are equal to each other.

### Example

Next, Example executed for verifying the effects of the exemplary embodiment of the present invention is described. In the verification, metal bus electrodes 4b and 5b, which are formed on a glass substrate by the same method as the above-mentioned production method, are used as samples. Herein, samples are formed in which the conditions at the time of development are adjusted and the undercut amounts are set to a range from 15 μm to 50 μm. Then, the line width after development, line width after firing, film thickness after firing, resistance value of metal bus electrodes 4b and 5b after firing, and edge curl amount after firing are measured. Furthermore, by using these results, the specific resistance value is calculated as an index of the conductivity. These results are shown in Table 1. In Table 1, the resistance value of metal bus electrodes 4b and 5b is shown as a resistance value of metal electrode. Furthermore, a specific resistance value is calculated by normalizing the resistance value with the sectional area and the length of metal bus electrodes 4b and 5b. Specifically, the specific resistance value is calculated by dividing the product of the resistance value and the sectional area of metal bus electrodes 4b and 5b by the length of metal bus electrodes 4b and 5b.

TABLE 1

| | | electrode | electrode | | resistance | specific |
|---|---|---|---|---|---|---|
| | undercut | line width | film thickness | edge curl | value of | resistance |
| | amount | after firing | after firing | amount | metal electrode | value |
| sample | 15 μm | 83 μm | 4.0 μm | 1.3 μm | 122Ω | 4.7 μΩ · cm |
| 1 | | | | | | |
| sample | 25 μm | 80 μm | 4.0 μm | 1.7 μm | 113Ω | 4.2 μΩ · cm |
| 2 | | | | | | |
| sample | 35 μm | 76 μm | 4.0 μm | 3.6 μm | 109Ω | 3.9 μΩ · cm |
| 3 | | | | | | |
| sample | 50 μm | 70 μm | 4.0 μm | 5.6 μm | 101Ω | 3.3 μΩ · cm |
| 4 | | | | | | |
| sample | 35 μm | 77 μm | 3.6 μm | 1.5 μm | 121Ω | 3.9 μΩ · cm |
| 5 | | | | | | |
| sample | 50 μm | 71 μm | 3.3 μm | 2.1 μm | 122Ω | 3.3 μΩ · cm |
| 6 | | | | | | |

Herein, the undercut amount is calculated by measuring width W2 of white electrode paste layer by transmitted light from the rear surface of the substrate and width W1 of the black electrode paste layer by both incident light and transmitted light by using a three-dimensional measurement device (product of V-TECHNOLOGY). Furthermore, the line width after firing is measured in a similar way. Then, the film thickness and the edge curl amount after firing are measured by measuring the sectional shape of the film by using a stylus type surface profile measuring instrument.

As shown in samples 1 to 4 in Table 1, it is shown that when the undercut amount is increased, although the film thickness is the same, the edge curl amount is increased and the resistance value and the specific resistance value of metal bus electrodes 4b and 5b are reduced. As mentioned above, this is thought to be because white electrodes 42b and 52b of metal bus electrodes 4b and 5b are denser and the conductivity is reduced according to the increase in the undercut amount. It is not desirable that the specific resistance value becomes larger than that of sample 2. Therefore, it is desirable that the undercut amount of metal bus electrodes 4b and 5b after development is 25 μm or more.

Furthermore, in samples 5 and 3 and samples 6 and 4, the undercut amounts are in the same level while the film thickness is changed. These results show that although samples 5 and 6 have the electrode resistance value and the edge curl amount that are the same level as those of sample 1, the electrode line width and the film thickness can be reduced. Herein, the edge curl amounts of metal bus electrodes 4b and 5b after firing in samples 1 to 6 are 32%, 42%, 90%, 140%, 42%, and 64% with respect to the film thickness of the metal bus electrode layer after firing. Thus, a drive voltage at the time of image display and the dielectric breakdown voltage of the dielectric layer are maintained to the same level while the electrode material to be used can be reduced, and the area of the opening capable of transmitting visible light of each discharge cell can be increased. Therefore, it is desirable that the edge curl amount of metal bus electrodes 4b and 5b after firing are 70% or less with respect to the film thickness of the metal bus electrode after firing.

As mentioned above, the PDP of the present invention includes a front panel having a display electrode and a dielectric layer formed on a glass substrate; and a rear panel having an electrode, a barrier rib, and a phosphor layer formed on a substrate. The front panel and rear panel are disposed facing each other and sealed together at peripheries thereof with discharge space provided therebetween. The display electrode has at least a metal bus electrode including a metal electrode layer containing silver and a glass material, and a black layer containing a black material and a glass material. Then, the glass material of the metal electrode layer and the black layer includes bismuth oxide. Furthermore, the undercut amount of the metal bus electrode after development is 25 μm or more. Furthermore, the edge curl amount of the metal bus electrode after firing may be 70% or less with respect to the film thickness of the metal bus electrode after firing. Then, the black layer may contain at least one of cobalt (Co), nickel (Ni), copper (Cu), oxide of cobalt (Co), oxide of nickel (Ni), and oxide of copper (Cu).

With such a configuration, even when an environmentally friendly material that does not contain a lead component is used, a PDP maintaining the resistance value of the display electrode and having high luminance and high reliability can be realized.

### INDUSTRIAL APPLICABILITY

As mentioned above, the present invention can realize a PDP which has a high quality image display and which is environmentally friendly. The PDP of the present invention is useful for a display device having a large screen.

1. A plasma display panel comprising:
a front panel including a display electrode and a dielectric layer formed on a glass substrate; and
a rear panel including an electrode, a barrier rib, and a phosphor layer formed on a substrate;
the front panel and the rear panel being disposed facing each other and sealed together at peripheries thereof with discharge space provided therebetween,
wherein the display electrode has at least a metal bus electrode including a metal electrode layer containing silver and a glass material, and a black layer containing a black material and a glass material;
the glass material of the metal electrode layer and the black layer includes bismuth oxide; and
an undercut amount of the metal bus electrode is 25 μm or more.

2. The plasma display panel of claim 1, wherein an edge curl amount of the metal bus electrode is 70% or less with respect to a film thickness of the metal bus electrode.

3. The plasma display panel of claim 1, wherein the black layer contains at least one of cobalt (Co), nickel (Ni), copper (Cu), oxide of cobalt (Co), oxide of nickel (Ni), and oxide of copper (Cu).
